(19) United States
(12) Patent Application Publication
(10) Pub. No.: US 2025/0112402 A1
(43) Pub. Date: Apr. 3, 2025

(54) CONNECTOR

(71) Applicant: SUMITOMO WIRING SYSTEMS, LTD., Mie (JP)

(72) Inventor: Takurou KAWAI, Mie (JP)

(21) Appl. No.: 18/893,266

(22) Filed: Sep. 23, 2024

(30) Foreign Application Priority Data
Sep. 29, 2023 (JP) 2023-170221

(51) Int. Cl. H01R 13/52

(52) U.S. Cl. CPC H01R 13/5205

(57) ABSTRACT

A connector 10 includes a housing including an accommodation hole 32, a terminal to be accommodated into the housing, a wire connected to the terminal, and a seal plug 23 for closing the accommodation hole 32 by being accommodated into the accommodation hole 32, the wire being passed through the seal plug 23. The housing includes a housing body 30 including the accommodation hole 32 and a seal plug mounting member 40 to be attached to the housing body 30. The seal plug mounting member 40 includes an introduction hole 41 continuous with an entrance end 33 of the accommodation hole 32. The introduction hole 41 is configured to deform the seal plug 23 in advance before the seal plug 23 is inserted into the accommodation hole 32 when the seal plug 23 is inserted into the introduction hole 41 and the accommodation hole 32.

### CROSS-REFERENCE TO RELATED APPLICATIONS

This application is based on and claims priority from Japanese Patent Application No. 2023-170221, filed on Sep. 29, 2023, with the Japan Patent Office, the disclosure of which is incorporated herein in its entirety by reference.

### TECHNICAL FIELD

The present disclosure relates to a connector.

### BACKGROUND

For example, a connector described in Japanese Patent Laid-open Publication No. 2021-197206 is provided with a housing, a terminal-equipped wire accommodated in the housing and a seal plug (rubber plug in Japanese Patent Laid-open Publication No. 2021-197206) mounted on the outer periphery of a wire of the terminal-equipped wire. The seal plug is accommodated into a cavity of the housing to close this cavity. The seal plug is provided with a plurality of lip portions (sealing portions in Japanese Patent Laid-open Publication No. 2021-197206) formed to project on the outer periphery of the seal plug. These respective lip portions are held in close contact with the inner peripheral surface of the cavity, whereby the sealability of the cavity is ensured.

### SUMMARY

In a connector as described above, a terminal-equipped wire having a large wire diameter may be generally used without changing a design of the housing. In this case, as the wire diameter increases, an outer diameter of a seal plug mounted on the terminal-equipped wire also increases. Thus, the seal plug may not be inserted to a proper position in the cavity of the connector housing. Unless the seal plug is inserted to the proper position in the cavity, parts of lip portions of the seal plug are, for example, not inserted in the cavity. In this way, the sealability of the seal plug may be deteriorated.

The present disclosure aims to provide a connector capable of improving the assemblability of a seal plug.

The present disclosure is directed to a connector with a housing including an accommodation hole, a terminal to be accommodated into the housing, a wire connected to the terminal, and a seal plug for closing the accommodation hole by being accommodated into the accommodation hole, the wire being passed through the seal plug, the housing including a housing body including the accommodation hole and a seal plug mounting member to be attached to the housing body, the seal plug mounting member including an introduction hole continuous with an entrance end of the accommodation hole, and the introduction hole being configured to deform the seal plug in advance before the seal plug is inserted into the accommodation hole when the seal plug is inserted into the introduction hole and the accommodation hole.

According to the connector of the present disclosure, the assemblability of the seal plug can be improved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector in one embodiment.

FIG. 2 is a perspective view of a housing body in the embodiment.

FIG. 3 is a side view enlargedly showing a part of the housing in the embodiment.

FIG. 4 is a section along 4-4 in FIG. 3.

FIG. 5 is a section along 5-5 in FIG. 3.

FIG. 6 is a diagram showing a relationship of an accommodation hole and an introduction hole in the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

Embodiments of the present disclosure are first listed and described.
[1] The connector of the present disclosure is provided with a housing including an accommodation hole, a terminal to be accommodated into the housing, a wire connected to the terminal, and a seal plug for closing the accommodation hole by being accommodated into the accommodation hole, the wire being passed through the seal plug, the housing including a housing body including the accommodation hole and a seal plug mounting member to be attached to the housing body, the seal plug mounting member including an introduction hole continuous with an entrance end of the accommodation hole, and the introduction hole being configured to deform the seal plug in advance before the seal plug is inserted into the accommodation hole when the seal plug is inserted into the introduction hole and the accommodation hole.

According to this configuration, when the seal plug mounted on the terminal-equipped wire is inserted into the housing, the seal plug is inserted in a deformed state into the accommodation hole after the being deformed in advance when passing through the introduction hole. In this way, the seal plug can be easily inserted to a proper position in the accommodation hole. As a result, the seal plug is held at the proper position, thereby being able to contribute to an improvement in sealability.
[2] In [1] described above, the accommodation hole may include a first straight portion having a uniform cross-sectional shape orthogonal to an axis of the accommodation hole in a direction along the axis, the cross-sectional shape of the first straight portion may be circular, the introduction hole may include a second straight portion having a uniform cross-sectional shape orthogonal to an axis of the introduction hole in a direction along the axis, and the cross-sectional shape of the second straight portion may be an oblong hole shape having a short diameter equal to a diameter of the first straight portion and a long diameter longer than the diameter of the first straight portion.

According to this configuration, the seal plug can be deformed mainly in a direction along the short diameter by the second straight portion of the introduction hole before the seal plug is inserted into the accommodation hole. By inserting the seal plug deformed in the direction along the short diameter into the accommodation hole, the seal plug can be easily inserted to the proper position in the accommodation hole.
[3] In [2] described above, the long diameter of the second straight portion may be set to be equal to an outer diameter of the seal plug in a state not mounted in the housing.

According to this configuration, a force for deforming the seal plug in a direction along the long diameter can be made smaller by the second straight portion of the introduction hole. A load applied to the seal plug in inserting the seal plug into the second straight portion can be suppressed to be small, with the result that contribution can be made to improving the assemblability of the seal plug.
[4] In [2] or [3] described above, the axis of the accommodation hole and the axis of the introduction hole may be parallel to each other, and one end part of the second straight portion in a direction along the long diameter may coincide with an inner peripheral surface of the first straight portion when viewed from the direction along the axis of the introduction hole.

According to this configuration, the deformation of the seal plug when the seal plug is inserted into the first straight portion of the accommodation hole can be concentrated only on one side in the direction along the long diameter. In this way, the seal plug can be easily inserted to the proper position in the accommodation hole.

### Details of Embodiment of Present Disclosure

A specific example of a connector of the present disclosure is described below with reference to the drawings. For the convenience of description, some components may be shown in an exaggerated or simplified manner in each drawing. Further, a dimension ratio of each part may be different in each drawing. Further, “parallel” and “orthogonal” in this specification mean not only strictly parallel and orthogonal, but also substantially parallel and orthogonal within a range in which functions and effects in this embodiment are achieved. Note that a term “tubular” used in the description of this specification indicates not only a shape formed by a peripheral wall continuous over an entire periphery in a circumferential direction, but also a shape formed by combining a plurality of components and a shape having a cut or the like in a circumferential part such as a C shape. Further, the “tubular” shapes include circular shapes, elliptical shapes and polygonal shapes with angular or rounded corners. Further, terms such as “first” and “second” in this specification are merely used to distinguish objects and do not rank the objects. Note that the present invention is not limited to these illustrations, but is represented by claims and intended to include all changes in the scope of claims and in the meaning and scope of equivalents.

### (Connector 10)

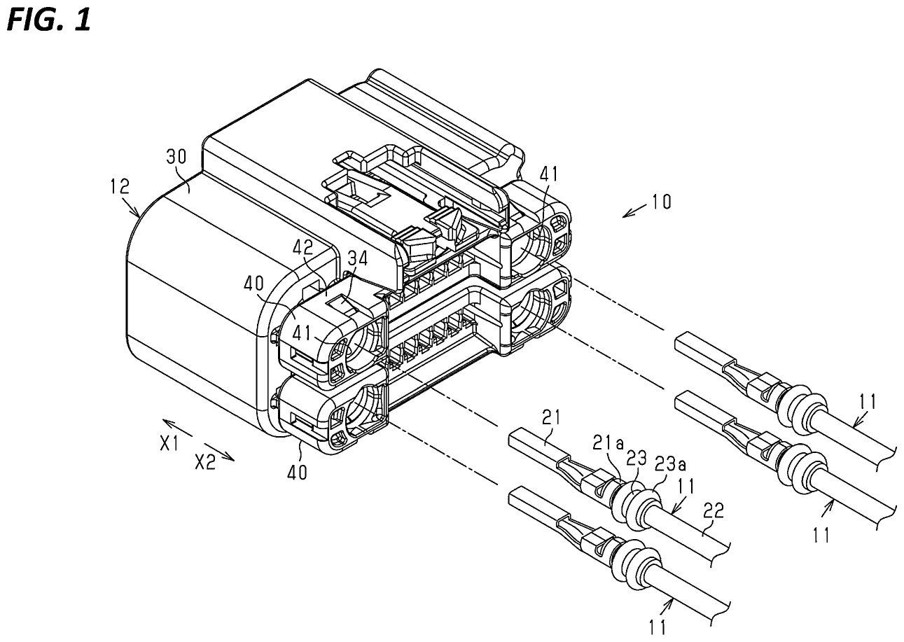

A connector 10 shown in FIG. 1 is connected to an unillustrated electrical device installed in a vehicle. The connector 10 is provided with terminal-equipped wires 11 and a housing 12 for holding the terminal-equipped wires 11. The housing 12 is connected to an unillustrated mating connector provided in the electrical device in a first direction X1. Note that a direction opposite to the first direction X1 is referred to as a second direction X2 in the following description.

### (Terminal-Equipped Wires 11)

The connector 10 includes, for example, a plurality of the terminal-equipped wires 11. The terminal-equipped wire 11 is provided with a terminal 21, a wire 22 and a seal plug 23. The terminal 21 is fixed to an end part in a length direction by crimping or the like. The terminal 21 is accommodated into the housing 12. With the connector 10 connected to the mating connector, the terminal 21 is connected to an unillustrated mating terminal provided in the mating connector.

### (Seal Plugs 23)

The seal plug 23 is, for example, a rubber plug made of silicon rubber or the like. The seal plug 23 has a substantially hollow cylindrical shape. The seal plug 23 is mounted on the outer periphery of the wire 22. That is, the wire 22 is passed through a hole inside the seal plug 23. Further, one end part in the length direction of the seal plug 23 is fixed to the outer peripheral surface of the wire 22 by a seal plug fixing portion 21a, which is a part of the terminal 21.

The seal plug 23 includes, for example, a plurality of lip portions 23a projecting from the outer peripheral surface of the seal plug 23. The plurality of lip portions 23a are provided in parallel while being spaced part from each other in the length direction of the wire 22. Each lip portion 23a is formed over the entire circumference of the seal plug 23.

### (Housing 12)

The housing 12 is provided with a housing body 30 and seal plug mounting members 40 to be attached to the housing body 30. The terminals 21 of the terminal-equipped wires 11 are accommodated in the housing body 30. Each of the housing body 30 and the seal plug mounting members 40 is, for example, made of synthetic resin.

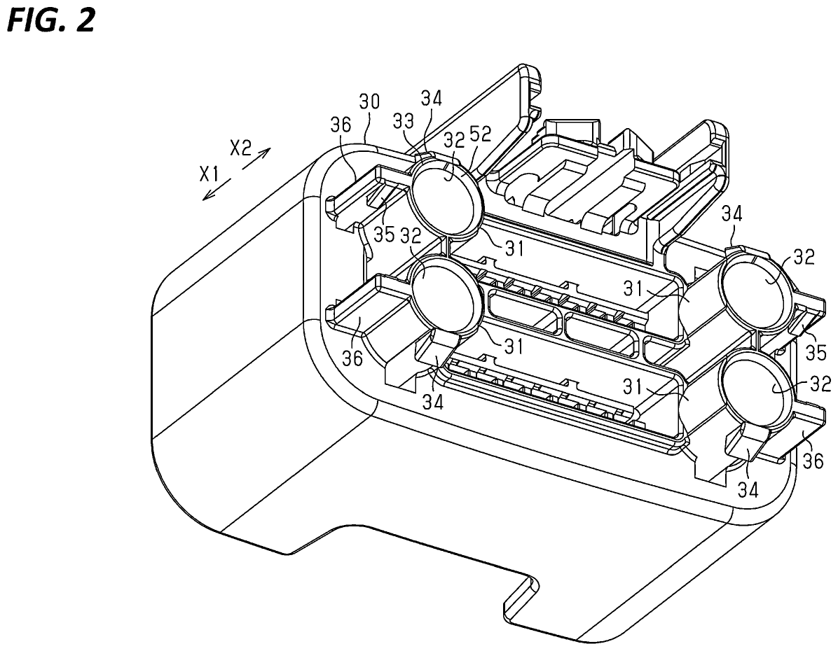

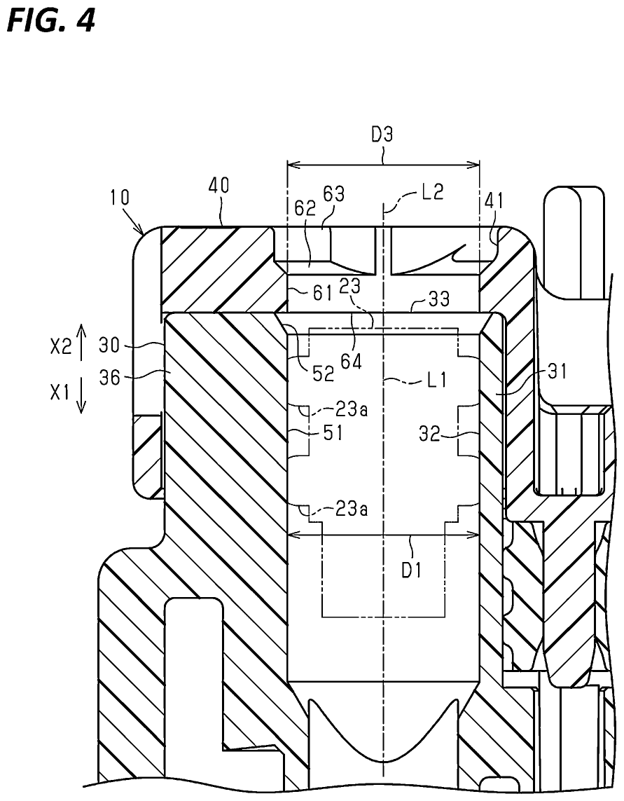

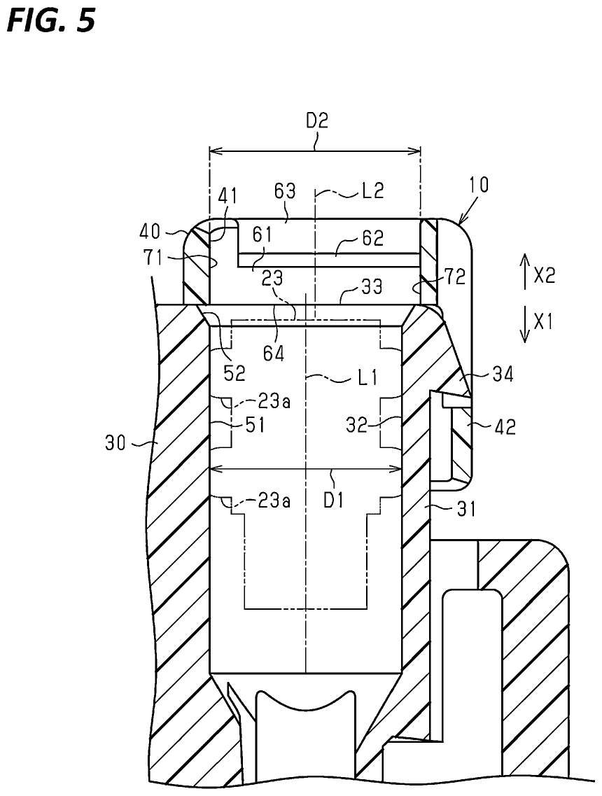

As shown in FIGS. 2 and 4, the housing body 30 includes, for example, mounting tube portions 31. The mounting tube portion 31 has a tubular shape extending in the second direction X2 (open in the second direction X2). The mounting tube portion 31 has, for example, a hollow cylindrical shape. The inner peripheral surface of the mounting tube portion 31 forms an accommodation hole 32 for accommodating the seal plug 23. The accommodation hole 32 has an entrance end 33 on the tip of the accommodation hole 32 in the second direction X2. The terminal-equipped wire 11 including the seal plug 23 is inserted into the accommodation hole 32 through the entrance end 33. The seal plug 23 closes the accommodation hole 32 by being accommodated into the accommodation hole 32. Note that, for the convenience of description, only the outer shape of the seal plug 23 is shown in the terminal-equipped wire 11 and the terminal 21 and the wire 22 are not shown in FIGS. 4 and 5.

### (Seal Plug Mounting Members 40)

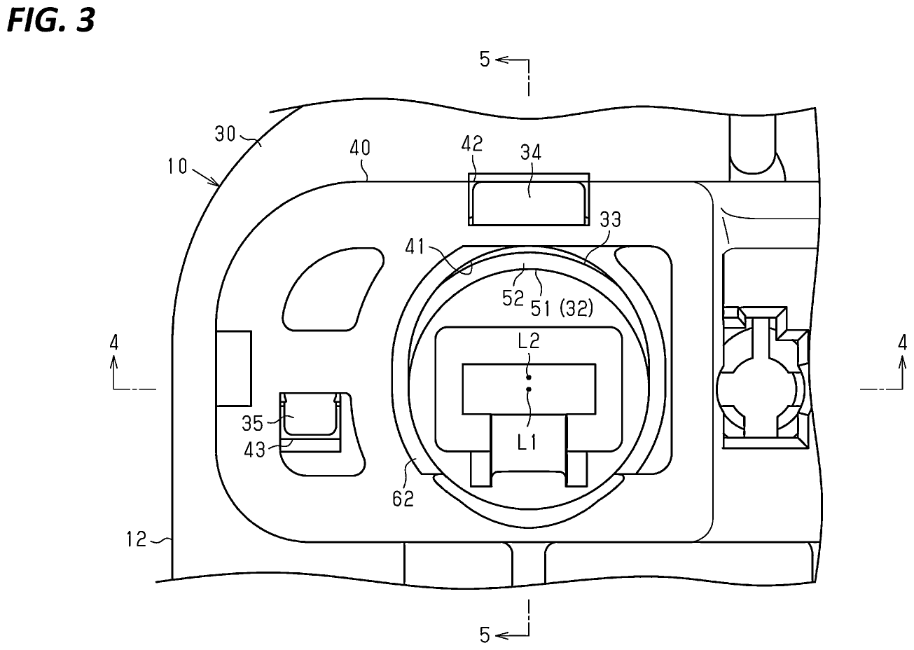

As shown in FIGS. 3 and 4, the seal plug mounting member 40 includes introduction holes 41 continuous with the entrance ends 33 of the accommodation holes 32 in the housing body 30. The introduction hole 41 is adjacent to the accommodation hole 32 of the housing body 30. That is, the accommodation hole 32 and the introduction hole 41 are configured such that the internal spaces thereof communicate.

As shown in FIG. 2, a plurality of the mounting tube portions 31 and a plurality of the accommodation holes 32 are, for example, provided in the housing body 30. The housing body 30 of this embodiment includes, for example, four mounting tube portions 31. That is, the housing body 30 of this embodiment includes four accommodation holes 32. Further, as shown in FIG. 1, the housing 12 is, for example, provided with a plurality of seal plug mounting members 40. The housing 12 of this embodiment is, for example, provided with two upper and lower seal plug mounting members 40. The two seal plug mounting members 40 have, for example, the same shape. Two introduction holes 41 are provided in each of the two seal plug mounting members 40. That is, a total of four introduction holes 41 are arranged to correspond to the respective four accommodation holes 32 in the housing body 30.

As shown in FIG. 3, the seal plug mounting member 40 includes, for example, first locking portions 42 and second locking portions 43 for fixing the seal plug mounting member 40 to the housing body 30. As shown in FIGS. 2 and 3, the housing body 30 includes first locked portions 34 to be locked by the first locking portions 42 of the seal plug mounting members 40 and second locked portions 35 to be locked by the second locking portions 43 of the seal plug mounting members 40.

As shown in FIG. 2, both the first and second locked portions 34, 35 are provided around each mounting tube portion 31. In particular, the first locked portion 34 projects from the outer peripheral surface of the mounting tube portion 31. With the seal plug mounting member 40 attached to the housing body 30, the first locking portions 42 of the seal plug mounting member 40 are hooked to the first locked portions 34 in the second direction X2.

The second locked portion 35 projects from a side surface of a wall portion 36 extending to an outer peripheral side from the mounting tube portion 31. With the seal plug mounting member 40 attached to the housing body 30, the second locking portions 43 of the seal plug mounting member 40 are hooked to the second locked portions 35 in the second direction X2.

In mounting the terminal-equipped wire 11 into the housing 12, the terminal 21 located on the tip of the terminal-equipped wire 11 is inserted into the accommodation hole 32 through the introduction hole 41 of the seal plug mounting member 40. At this time, the terminal 21 is inserted along the first direction X1. With the terminal 21 accommodated inside the housing body 30, the entire seal plug 23 is accommodated in the accommodation hole 32. Further, the wire 22 is drawn out to the outside of the housing 12 in the second direction X2 through the accommodation hole 32.

### (Detailed Configuration of Accommodation Hole 32)

The detailed shape of the accommodation hole 32 in the housing body 30 is described below. Note that the four accommodation holes 32 located on upper and lower left and right sides have, for example, the same shape.

As shown in FIGS. 3, 4 and 5, the accommodation hole 32 has a first axis L1 parallel to the second direction X2. The accommodation hole 32 is open in the second direction X2. The accommodation hole 32 has the entrance end 33 on the tip of the accommodation hole 32 in the second direction X2. The terminal-equipped wire 11 including the seal plug 23 is inserted into the accommodation hole 32 through the entrance end 33. The accommodation hole 32 has a circular cross-sectional shape orthogonal to the first axis L1 and centered on the first axis L1, for example, over the entire accommodation hole 32 in an axial direction.

The accommodation hole 32 includes, for example, a first straight portion 51 and a first enlarged diameter portion 52. The first straight portion 51 has a circular cross-sectional shape orthogonal to the first axis L1. Further, the cross-sectional shape of the first straight portion 51 orthogonal to the first axis L1 is uniform in a direction along the first axis L1. That is, the first straight portion 51 linearly extends along the first axis L1.

In the accommodation hole 32, the first enlarged diameter portion 52 is provided between the first straight portion 51 and the entrance end 33. The first enlarged diameter portion 52 is provided over the entire circumference of the accommodation hole 32. The first enlarged diameter portion 52 has an inclined shape enlarged in diameter from one axial end of the first straight portion 51 toward the entrance end 33. The first enlarged diameter portion 52 has, for example, a circular cross-sectional shape orthogonal to the first axis L1. An end part of the first enlarged diameter portion 52 on a side opposite to the first straight portion 51 forms the entrance end 33 of the accommodation hole 32. That is, a diameter of the entrance end 33 is set to be larger than a diameter D1 of the first straight portion 51.

### (Detailed Configuration of Introduction Hole 41)

The detailed shape of the introduction hole 41 in the seal plug mounting member 40 is described below. Note that the respective introduction holes 41 have, for example, the same shape. The introduction hole 41 is configured to deform the seal plug 23 in advance before the seal plug 23 is inserted into the accommodation hole 32 when the seal plug 23 is inserted into the introduction hole 41 and the accommodation hole 32.

The introduction hole 41 has a second axis L2 parallel to the first direction X1. The second axis L2 of the introduction hole 41 is parallel to the first axis L1 of the accommodation hole 32. Further, the second axis L2 of the introduction hole 41 is set not to be located on the same straight line as the first axis L1 of the accommodation hole 32.

The introduction hole 41 includes a second straight portion 61 and a second enlarged diameter portion 62. A circular cross-sectional shape of the second straight portion 61 orthogonal to the second axis L2 is uniform in a direction along the second axis L2. That is, the second straight portion 61 linearly extends along the second axis L2.

The introduction hole 41 has a first opening end 63 and a second opening end 64, which are both end parts in the direction along the second axis L2. With the seal plug mounting member 40 attached to the housing body 30, the second opening ends 64 are facing the entrance ends 33 of the accommodation holes 32. The first opening end 63 serves as an entrance when the terminal-equipped wire 11 including the seal plug 23 is inserted into the introduction hole 41. The second enlarged diameter portion 62 in the introduction hole 41 is provided between the second straight portion 61 and the first opening end 63. The second enlarged diameter portion 62 has an inclined shape enlarged in diameter from one axial end of the second straight portion 61 toward the first opening end 63. In the introduction hole 41 of this embodiment, an opening area (area in a plane orthogonal to the second axis L2) of each of the first and second opening ends 63, 64 is set to be larger than a cross-sectional area of the accommodation hole 32.

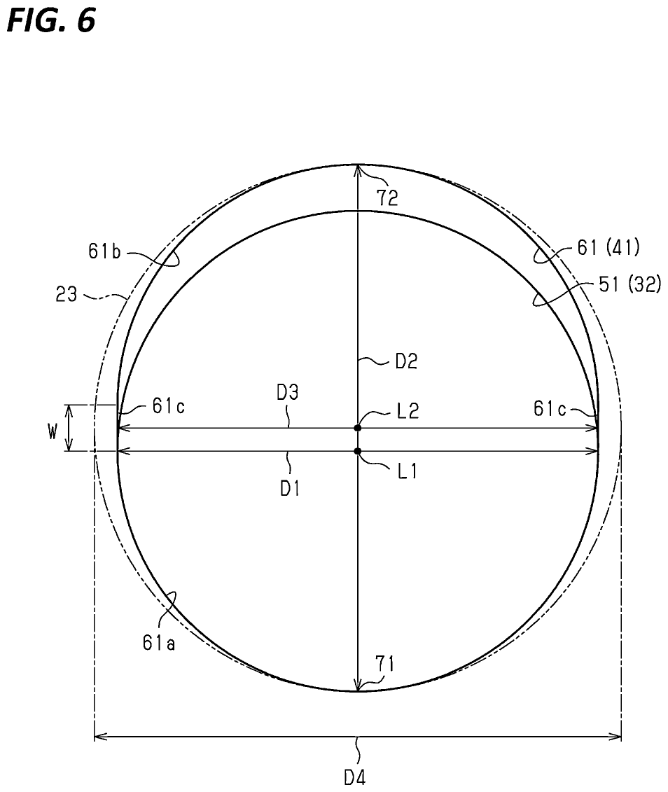

The shape of the first straight portion 51 of the accommodation hole 32 and that of the second straight portion 61 of the introduction hole 41 when viewed from the axial direction are schematically shown in solid line in FIG. 6. Further, the outer shape of the seal plug 23 (outer shape of the lip portion 23a) when viewed from the axial direction in a state not mounted in the housing 12 is schematically shown by two-dot chain line in FIG. 6.

As shown in FIG. 6, a cross-sectional shape of the second straight portion 61 orthogonal to the second axis L2 is an oblong hole shape having a long diameter D2 and a short diameter D orthogonal to each other. The long diameter D2 is set to be longer than the diameter D1 of the first straight portion 51. The short diameter D3 is set to be equal to the diameter D1 of the first straight portion 51. The long diameter D2 in the second straight portion 61 is set to be equal to an outer diameter D4 of the seal plug 23 in the state not mounted in the housing 12. Note that the outer diameter D4 of the seal plug 23 is a diameter of a top part (outermost peripheral part) of the lip portion 23a.

An example of the shape of the second straight portion 61 when viewed from the direction along the second axis L2 is described below. When viewed from the direction along the second axis L2, the inner peripheral surface of the second straight portion 61 includes a first semicircular part 61a, a second semicircular part 61b and a pair of straight parts 61c. The first and second semicircular parts 61a, 61b have a semicircular shape having an equal radius. The shapes of the first and second semicircular parts 61a, 61b are inverted from each other by 180° about the second axis L2. The radius of each of the first and second semicircular parts 61a, 61b is set to be equal to a radius (half the diameter D1) of the first straight portion 51 in the accommodation hole 32. The pair of straight parts 61c are located between the first and second semicircular parts 61a, 61b. When viewed from the direction along the second axis L2, the first semicircular part 61a on the inner peripheral surface of the second straight portion 61 overlaps a semi-circumference of the inner peripheral surface of the first straight portion 51 in the accommodation hole 32. That is, the projection of the first semicircular part 61a in the direction along the second axis L2 (first direction X1) overlaps the semi-circumference of the inner peripheral surface of the first straight portion 51. Further, the projection of the second semicircular part 61b in the direction along the second axis L2 (first direction X1) is shifted from the inner peripheral surface of the first straight portion 51 by a width W of the straight part 61c.

On the inner peripheral surface of the second straight portion 61, both end parts in a direction along the long diameter D2 are respectively a first long diameter end part 71 and a second long diameter end part 72. The first long diameter end part 71 is included in the first semicircular part 61a. The second long diameter end part 712 is included in the second semicircular part 61b. A distance from the first long diameter end part 71 to the second long diameter end part 72 is equal to the long diameter D2 of the second straight portion 61. When viewed from the direction along the second axis L2, the position of the first long diameter end part 71 coincides with the position of the inner peripheral surface of the first straight portion 51. That is, the projection of the first long diameter end part 71 in the direction along the second axis L2 overlaps the inner peripheral surface of the first straight portion 51. Further, the projection of the second long diameter end part 72 in the direction along the second axis L2 is located on an outer peripheral side of the first straight portion 51. In this way, a circumferential part of the first enlarged diameter portion 52 in the accommodation hole 32 is exposed through the introduction hole 41 when viewed from the first direction X1 (see FIGS. 3 and 5).

Functions of this embodiment are described.

In mounting the terminal-equipped wire 11 into the housing 12, the terminal-equipped wire 11 including the seal plug 23 is inserted into the accommodation hole 32 of the housing body 30 in the first direction X1 through the introduction hole 41 of the seal plug mounting member 40. At this time, the seal plug 23 is deformed by the second straight portion 61 of the introduction hole 41 before being inserted into the accommodation hole 32. Here, a stage in which the seal plug 23 is deformed by being inserted into the introduction hole 41 is referred to as a preliminary deformation stage. In the preliminary deformation stage, the seal plug 23 is deformed to be mainly squeezed in a direction along the short diameter D3 of the second straight portion 61 in the introduction hole 41. Note that, when being inserted into the introduction hole 41, the seal plug 23 first comes into contact with the second enlarged diameter portion 62 in the introduction hole 41 in the first direction X1. In this way, the seal plug 23 is deformed toward an inner peripheral side of the introduction hole 41 along the inclination of the second enlarged diameter portion 62.

After the preliminary deformation stage, the seal plug 23 is inserted into the accommodation hole 32 of the housing body 30 while being kept deformed by the first straight portion 51. At this time, the seal plug 23 is deformed to be mainly squeezed in a direction orthogonal to a deformation direction in the preliminary deformation stage (direction along the long diameter D2 of the second straight portion 61) by the first straight portion 51 of the accommodation hole 32. Note that, when the seal plug 23 is inserted into the introduction hole 41 after the preliminary deformation stage, a circumferential part (part corresponding to the second semicircular part 61b) of the seal plug 23 comes into contact with the first enlarged diameter portion 52 in the accommodation hole 32 in the first direction X1. In this way, the seal plug 23 is deformed toward an inner peripheral side of the accommodation hole 32 along the inclination of the first enlarged diameter portion 52.

By inserting the seal plug 23 deformed in advance by the introduction hole 41 into the accommodation hole 32 in this way, the seal plug 23 can be inserted to a proper position in the first straight portion 51 of the accommodation hole 32. This proper position of the seal plug 23 is a position where the sealability of the seal plug 23 is ensured. With the seal plug 23 located at this proper position, all of the plurality of lip portions 23a on the seal plug 23 are resiliently held in close contact with the inner peripheral surface of the first straight portion 51. Further, with the seal plug 23 located at this proper position, the seal plug 23 is located over an entire length in the accommodation hole 32 in the length direction of the wire 22. That is, with the seal plug 23 located at this proper position, the seal plug 23 is not located in the introduction hole 41 of the seal plug mounting member 40.

Effects of this embodiment are described.
(1) The seal plug mounting member 40 includes the introduction holes 41 continuous with the entrance ends 33 of the accommodation holes 32. The introduction hole 41 is configured to deform the seal plug 23 in advance before the seal plug 23 is inserted into the accommodation hole 32 when the seal plug 23 is inserted into the introduction hole 41 and the accommodation hole 32. According to this configuration, in mounting the seal plug 23 mounted on the terminal-equipped wire 11 into the housing 12, the seal plug 23 in a deformed state is inserted into the accommodation hole 32 after being deformed in advance when passing through the introduction hole 41. In this way, the seal plug 23 can be easily inserted to the proper position in the accommodation hole 32. As a result, the seal plug 23 is held at the proper position, which can contribute to an improvement in sealability. Further, the introduction holes 41 are provided in the seal plug mounting member 40 separate from the housing body 30 including the accommodation holes 32. Thus, the formability of the accommodation holes 32 can be improved as compared to the case where the introduction holes 41 are integrally formed with the accommodation holes 32 in the housing body 30.
(2) The accommodation hole 32 includes the first straight portion 51 having a uniform cross-sectional shape in the direction along the first axis L1 of the accommodation hole 32. The first straight portion 51 has a circular cross-sectional shape. The introduction hole 41 includes the second straight portion 61 having a uniform cross-sectional shape in the direction along the second axis L2 of the introduction hole 41. The cross-sectional shape of the second straight portion 61 is an oblong hole shape having the short diameter D3 equal to the diameter D1 of the first straight portion 51 and the long diameter D2 longer than the diameter D1 of the first straight portion 51. According to this configuration, the seal plug 23 can be deformed mainly in the direction along the short diameter D3 by the second straight portion 61 of the introduction hole 41 before the seal plug 23 is inserted into the accommodation hole 32. By inserting the seal plug 23 deformed in the direction along the short diameter D3 into the accommodation hole 32, the seal plug 23 can be easily inserted to the proper position in the accommodation hole 32.
(3) The long diameter D2 in the second straight portion 61 is set to be equal to the outer diameter D4 of the seal plug 23 in the state not mounted in the housing 12. According to this configuration, a force for deforming the seal plug 23 in the direction along the long diameter D2 by the second straight portion 61 of the introduction hole 41 can be made smaller. A load applied to the seal plug 23 in inserting the seal plug 23 into the second straight portion 61 can be suppressed to be small, with the result that contribution can be made to improving the assemblability of the seal plug 23.
(4) The first axis L1 of the accommodation hole 32 and the second axis L2 of the introduction hole 41 are parallel to each other. When viewed from the direction along the second axis L2 of the introduction hole 41, one end part (first long diameter end part 71) of the second straight portion 61 in the direction along the long diameter D2 coincides with the inner peripheral surface of the first straight portion 51. According to this configuration, the deformation of the seal plug 23 in inserting the seal plug 23 into the first straight portion 51 of the accommodation hole 32 can be concentrated only on one side in the direction along the long diameter D2 (only a part corresponding to the second semicircular part 61b). In this way, the seal plug 23 can be easily inserted to the proper position in the accommodation hole 32.

### (Other Embodiments)

The above embodiment can be modified and carried out as follows. The above embodiment and the following modifications can be carried out in combination without technically contradicting each other.
In the above embodiment, the first axis L1 of the accommodation hole 32 and the second axis L2 of the introduction hole 41 may be located on the same straight line. That is, when viewed from the direction along the second axis L2, both the first and second long diameter end parts 71, 72 of the second straight portion 62 may be located on the outer peripheral side of the inner peripheral surface of the first straight portion 51.
In the above embodiment, the long diameter D2 in the second straight portion 61 may be set to be smaller than the outer diameter D4 of the seal plug 23 in the state not mounted in the housing 12. Further, in the above embodiment, the long diameter D2 in the second straight portion 61 may be set to be larger than the outer diameter D4 of the seal plug 23 in the state not mounted in the housing 12.
In the above embodiment, the short diameter D3 in the second straight portion 61 may be set to be larger than the diameter D1 of the first straight portion 51 and smaller than the long diameter D2 of the second straight portion 61.
The oblong hole shape of the second straight portion 61 in the introduction hole 41 is not limited to the shape of the above embodiment and can be changed as appropriate. For example, the second straight portion 61 needs not necessarily include the pair of straight parts 61c, and the shape of the second straight portion 61 when viewed from the direction along the second axis L2 may be an elliptical shape not including the pair of straight parts 61c. Further, the cross-sectional shape of the second straight portion 61 orthogonal to the second axis L2 is not limited to the oblique hole shape and can be changed as appropriate according to the configuration of the seal plug 23.
The shape of the introduction hole 41 is not limited to that of the above embodiment and can be changed as appropriate. For example, the introduction hole 41 may be entirely reduced in diameter from the first opening end 41 to the second opening end 42 along the second axis L2. In this case, the introduction hole 41 may have a circular cross-sectional shape orthogonal to the second axis L2.
The number of the terminal-equipped wires 11 including the seal plugs 23 and the numbers of the accommodation holes 32 and the introduction holes 41 corresponding to the terminal-equipped wires 11 are not limited to those of the above embodiment and can be changed as appropriate according to the configuration of the connector 10.
The embodiment disclosed this time is illustrative in all aspects, and the present invention is not limited to these illustrations. That is, the scope of the present invention is represented by claims and intended to include all changes in the scope of claims and in the meaning and scope of equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a housing including an accommodation hole;
a terminal to be accommodated into the housing;
a wire connected to the terminal; and
a seal plug for closing the accommodation hole by being accommodated into the accommodation hole, the wire being passed through the seal plug,
the housing including a housing body including the accommodation hole and a seal plug mounting member to be attached to the housing body,
the seal plug mounting member including an introduction hole continuous with an entrance end of the accommodation hole, and
the introduction hole being configured to deform the seal plug in advance before the seal plug is inserted into the accommodation hole when the seal plug is inserted into the introduction hole and the accommodation hole.

2. The connector of claim 1, wherein:
the accommodation hole includes a first straight portion having a uniform cross-sectional shape orthogonal to an axis of the accommodation hole in a direction along the axis,
the cross-sectional shape of the second straight portion is circular,
the introduction hole includes a second straight portion having a uniform cross-sectional shape orthogonal to an axis of the introduction hole in a direction along the axis, and
the cross-sectional shape of the second straight portion is an oblong hole shape having a short diameter equal to a diameter of the first straight portion and a long diameter longer than the diameter of the first straight portion.

3. The connector of claim 2, wherein the long diameter of the first straight portion is set to be equal to an outer diameter of the seal plug in a state not mounted in the housing.

4. The connector of claim 2, wherein:
the axis of the accommodation hole and the axis of the introduction hole are parallel to each other, and
one end part of the second straight portion in a direction along the long diameter coincides with an inner peripheral surface of the first straight portion when viewed from the direction along the axis of the introduction hole.
